(19) United States
(12) Patent Application Publication
(10) Pub. No.: US 2012/0137541 A1
(43) Pub. Date: Jun. 7, 2012

(54) SHOCK ABSORBING UNIT, SOLE AND SHOE HAVING THE SAME

(75) Inventor: Woon Kwang YEO, Yongin-si (KR)

(73) Assignee: SHELTON SPORTS CO., LTD., Seoul (KR)

(21) Appl. No.: 12/978,509

(22) Filed: Dec. 24, 2010

(30) Foreign Application Priority Data
Dec. 7, 2010 (KR) 10-2010-0124397

(51) Int. Cl. A43B 13/18; F16F 7/00; F16F 1/00

(52) U.S. Cl. 36/27; 267/136

(57) ABSTRACT

A shock absorbing unit, a sole and a shoe having the shock absorbing unit are provided. The shock absorbing sole includes a first holding member mounted on an outsole, a first locking part placed on the first holding member and having on an upper surface an annular seating part, an elastic member seated in a receiving part of the first locking part, a second locking part mounted on the elastic member and having on a lower surface an annular seating part, a second holding member placed on the second locking part, an upper sole placed on the second holding member and having a second receiving part for the second holding member, and a supporting member having a receiving part that receives the elastic member and connected at opposite ends to the first and second locking parts.

### CROSS REFERENCE TO RELATED APPLICATION

This application claims the benefit under 35 U.S.C. 119(a) of Korean Patent Application No. 10-2010-0124397 filed Dec. 7, 2010, the content of which is incorporated herein by reference in its entirety.

### BACKGROUND OF THE INVENTION

1. Field of the Invention

The present invention relates generally to a shock absorbing unit, a sole and a shoe having the shock absorbing unit and, more particularly, to a shock absorbing unit, a sole and a shoe having the shock absorbing unit, in which a supporting member having the shape of an airbag tube is provided to prevent the removal or separation of a coil spring that is a rebound resilient member supporting the arch portion and the calcaneus of the heel, thus increasing the durability of the shoe, and in which the supporting member having the shape of the airbag tube can be easily and conveniently coupled to the sole by a high-frequency heat-treatment adhesion method, so that a working period is reduced, assembling work is easy, and adhesiveness is very excellent, thus increasing productivity, affording easy maintenance, and improving work efficiency.

2. Description of the Related Art

Generally, shoes function to protect a person's feet and absorb shock, thus reducing the fatigue of the feet. Recently, a variety of functional shoes that emphasize the functionality of shoes have been proposed.

FIG. 1 shows a conventional shock absorbing shoe. The shock absorbing shoe is assembled in various forms to make the maintenance of the coil spring 40, which is elastically deformed, convenient.

Conventionally, in order to couple the coil spring to the shoe, various methods have been adopted. For example, the coil spring may be installed in a heel of the shoe or may be coupled to the heel using a holding member or a bolt.

FIG. 2 is an exploded perspective view showing a shock absorbing unit of the conventional shock absorbing shoe, and FIG. 3 is a sectional view showing the conventional shock absorbing unit. Referring to the drawings, coil springs 40 serving as an elastic body are placed between an outsole 10 and an upper sole 60. Locking parts 35 and 37 are provided on the upper and lower ends of the coil springs 40 to lock the coil springs 40 to predetermined positions. Holding members 30a and 30b are provided to hold the locking parts 35 and 37. Further, connecting pins 50 are provided to pass through the holding members 30a and 30b and the locking parts 35 and 37, thus fastening the coil springs 40.

The conventional shock absorbing shoe absorbs shock applied to a wearer during walking, using the elastic forte of the coil springs 40.

However, the conventional shock absorbing unit is problematic in that, when a load is continuously applied to the coil springs 40 and thus the coil springs 40 are compressed, very large shock is caused by the contact of the coil springs 40, so that the shock absorbing unit may be broken or damaged.

Especially, the conventional shock absorbing unit is problematic in that, whenever a load is applied to the shock absorbing unit, a head of each connecting pin 50 continues to strike a cavity 61 formed in the upper sole 60, so that portion ‘A’ of the upper sole 60 may be damaged and the head of the connecting pin 50 may pass through the upper sole 60 and protrude to the outside.

Further, the conventional shock absorbing unit is problematic in that the coil springs 40 are exposed to the outside, they are vulnerable to foreign matter and are apt to be damaged, so that it is inefficient in terms of economics because maintenance must be sought out to replace or repair the damaged coil springs 40, thereby dealing consumers a fatal blow in terms of reliability.

Further, since the locking parts 35 and 37 and the holding members 30a and 30b are made of different materials, the locking parts 35 and 37 are adhered to the holding members 30a and 30b using an adhesive such as glue. However, if the adhesive force drops while the shoe is being used, the locking parts 35 and 37 may undesirably separate themselves from the holding to members 30a and 30b.

### SUMMARY OF THE INVENTION

Accordingly, the present invention has been made keeping in mind the above problems occurring in the prior art, and an object of the present invention is to provide a shock absorbing unit, in which a supporting member having the shape of an airbag tube is provided and a coil spring is accommodated in the supporting member, thus preventing the removal or separation of the coil spring, and which is mounted to various kinds of shoes, thus making a wearer's feet comfortable.

Another object of the present invention is to provide a shock absorbing unit, in which a supporting member having the shape of an airbag tube is adhered to a locking part for locking a coil spring, thus preventing the entrance of foreign matter, preventing the coil spring from rusting or becoming damaged or removed, and allowing the coil spring to be stably mounted, therefore considerably enhancing the durability of a shoe.

A further object of the present invention is to provide a shock absorbing unit, in which a locking part and a supporting member are made of the same type of thermoplastic polyurethane (TPU) material, so that they may be adhered to each other by a high-frequency heat-treatment adhesion method and an adhered portion is firmly attached and never separates, thus allowing a wearer to reliably use the shock absorbing unit.

Yet another object of the present invention is to provide a shock absorbing sole, which omits a conventional connecting pin for mounting a coil spring and includes a supporting member having the shape of an airbag tube to support a coil spring, thus preventing an upper sole or the coil spring from becoming damaged.

A still further object of the present invention is to provide a shock absorbing sole, in which a supporting member is adhered to an upper sole and a holding member, so that, when a coil spring is compressed and then restored during walking, the relative movement of the supporting member is received and guided, thus guaranteeing the operational reliability of the coil spring, and allowing the supporting member accommodating the coil spring and the holding member holding the supporting member at each of upper and lower positions to be easily and conveniently coupled to each other, therefore making it easy to assemble and reducing the work time, resulting in increasing productivity.

An additional object of the present invention is to provide a shoe, which remarkably improves an adhesive force between a locking part and a holding member, thus preventing the locking part and the holding member from separating from each other when the shoe is being used.

In order to accomplish the above objects, the present invention provides a shock absorbing unit inserted into a sole or heel of a shoe, including an elastic member absorbing shock of a wearer during walking, a first locking part placed under the elastic member and having on an upper surface thereof an annular seating part so that an end of the elastic member is seated therein, a second locking part placed above the elastic member and having on a lower surface thereof an annular seating part so that an end of the elastic member is seated therein, and a supporting member having a receiving part that receives the elastic member and connected at opposite ends thereof to the first and second locking parts.

The elastic member may be selected from a group consisting of a plate coil spring having a rectangular cross-section and a coil spring having a circular cross-section.

The supporting member may have a shape of an airbag tube which receives the elastic member and is compressed or restored to correspond, to an operation of the elastic member that is compressed or restored during walking.

The supporting member may be made of a soft material, and the receiving part may to have a bulged shape, so that, if the supporting member is subjected to shock when a wearer walks, the receiving part may be compressed to support the elastic member.

The supporting member may be made of a soft material, and the receiving part may have a plurality of wrinkles formed in a horizontal direction, so that, if the supporting member is subjected to shock when the wearer walks, the wrinkles of the receiving part may be compressed to support the elastic member.

The first and second locking parts and the supporting member may be thermally bonded to each other by a high-frequency heat-treatment adhesion method.

The first and second locking parts may be made of a thermoplastic polyurethane (TPU) material, and the supporting member may be made of a soft TPU material.

Further, in order to accomplish the above objects, the present invention provides a shock absorbing sole, including a first holding member mounted on an outsole, a shock absorbing unit mounted on the first holding member and absorbing shock when a wearer walks, a second holding member placed on the shock absorbing unit, and an upper sole placed on the second holding member, wherein the shock absorbing unit includes an elastic member absorbing shock of the wearer during walking, a first locking part placed under the elastic member and having on an upper surface thereof an annular seating part so that an end of the elastic member is seated therein, a second locking part placed above the elastic member and having on a lower surface thereof an annular seating part so that an end of the elastic member is seated therein, and a supporting member having a receiving part that receives the elastic member and connected at opposite ends thereof to the first and second locking parts.

The elastic member may be selected from a group consisting of a plate coil spring having a rectangular cross-section and a coil spring having a circular cross-section.

The supporting member may have a shape of an airbag tube which receives the elastic member and is compressed or restored to correspond to an operation of the elastic member that is compressed or restored during walking.

The supporting member may be made of a soft material, and the receiving part may have a bulged shape, so that, if the supporting member is subjected to shock when a wearer walks, the receiving part may be compressed to support the elastic member.

The supporting member may be made of a soft material, and the receiving part may have a plurality of wrinkles formed in a horizontal direction, so that, if the supporting member is subjected to shock when the wearer walks, the wrinkles of the receiving part may be compressed to support the elastic member.

The first and second locking parts and the supporting member may be thermally bonded to each other by a high-frequency heat-treatment adhesion method.

The first and second locking parts may be made of a thermoplastic polyurethane (TPU) material, and the supporting member may be made of a soft TPU material.

The first and second locking parts and the first and second holding members may be thermally bonded to each other by a high-frequency heat-treatment adhesion method.

The first and second locking parts and the first and second holding members may be made of a thermoplastic polyurethane (TPU) material.

One shock absorbing unit may be provided at a position which is in contact with a wearer's calcaneus, thus absorbing shock.

Four shock absorbing units may be provided to support a wearer's calcaneus.

Furthermore, in order to accomplish the above objects, the present invention provides a shoe having the above-mentioned shock absorbing unit, wherein the shock absorbing unit is mounted to a position which is in contact with a wearer's calcaneus in such a way as to be inserted into a heel or exposed to an outside of the heel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a conventional shock absorbing shoe;

FIG. 2 is an exploded perspective view showing a shock absorbing unit of the conventional shock absorbing shoe;

FIG. 3 is a sectional view showing the conventional shock absorbing

FIG. 4 is a perspective view showing a shock absorbing unit according to an embodiment of the present invention;

FIGS. 5A and 5B are front views showing shock absorbing units according to other embodiments of the present invention;

FIG. 6 is a side view showing a sole for a shoe having four shock absorbing units according to the present invention;

FIG. 7 is a rear view showing the sole for the shoe having the four shock absorbing units according to the present invention;

FIG. 8 is a side view showing a shoe according to an embodiment of the present invention, in which one shock absorbing unit is inserted into the shoe;

FIG. 9 is a side view showing a shoe according to another embodiment of the present invention, in which one shock absorbing unit is inserted into the shoe;

FIG. 10 is a side view showing a woman's shoe into which the shock absorbing unit of the present invention is inserted; and

FIG. 11 is a side view showing a heel of a woman's shoe to which the shock absorbing unit of the present invention is mounted.

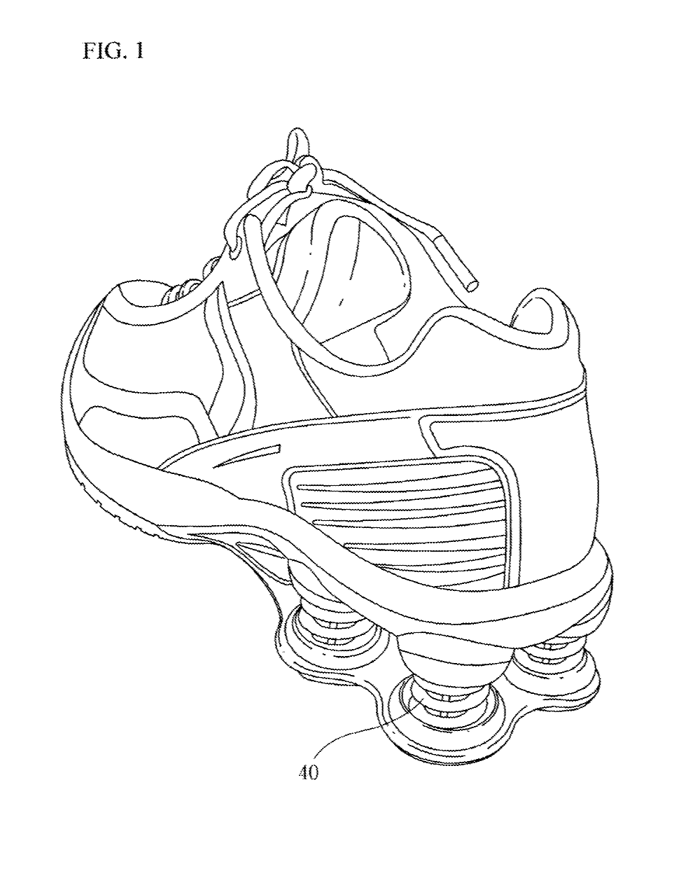

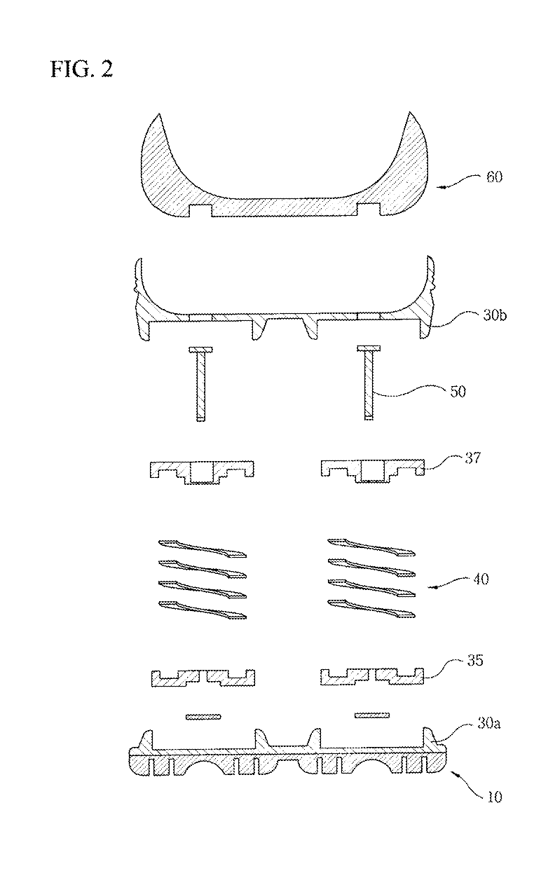

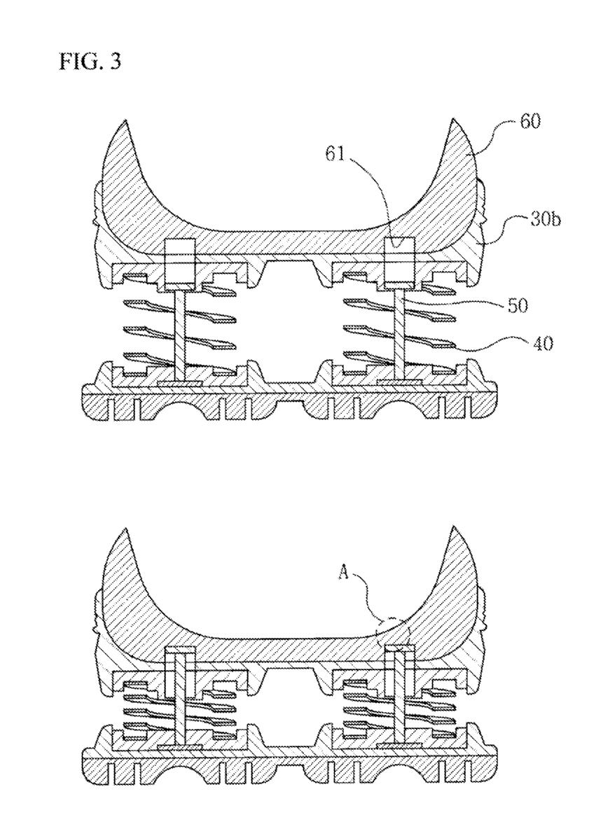

### DESCRIPTION OF THE PREFERRED EMBODIMENTS

Hereinafter, a shock absorbing sole and a shoe having the shock absorbing sole according to the present invention will be described in detail with reference to the accompanying drawings.

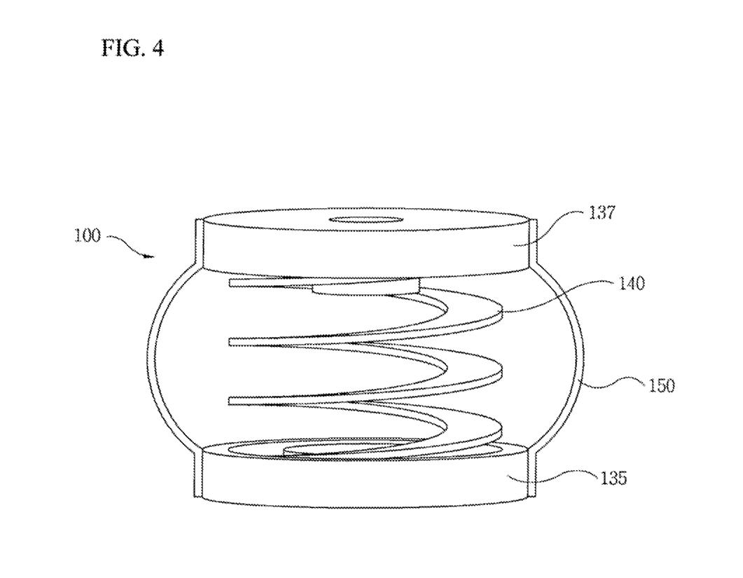

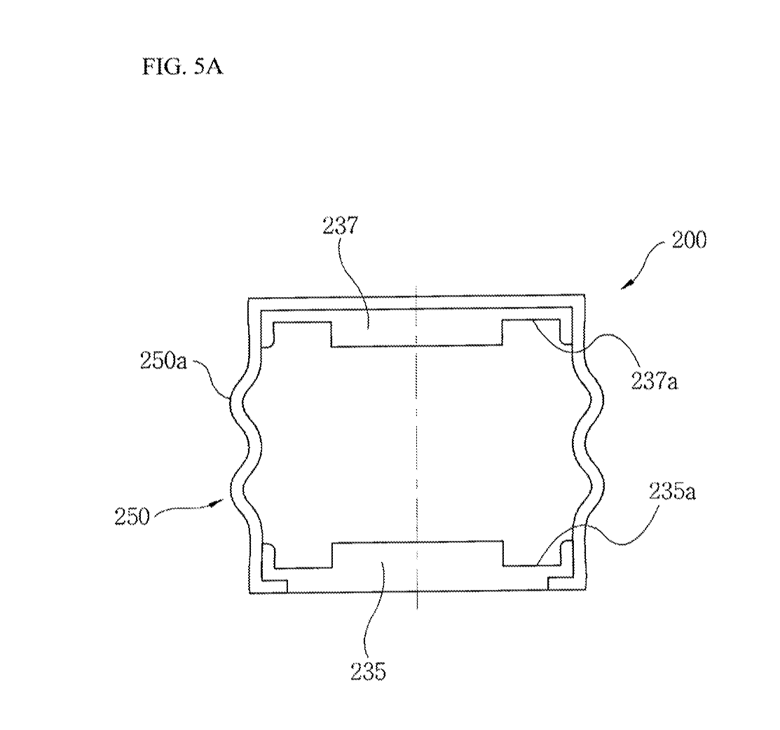

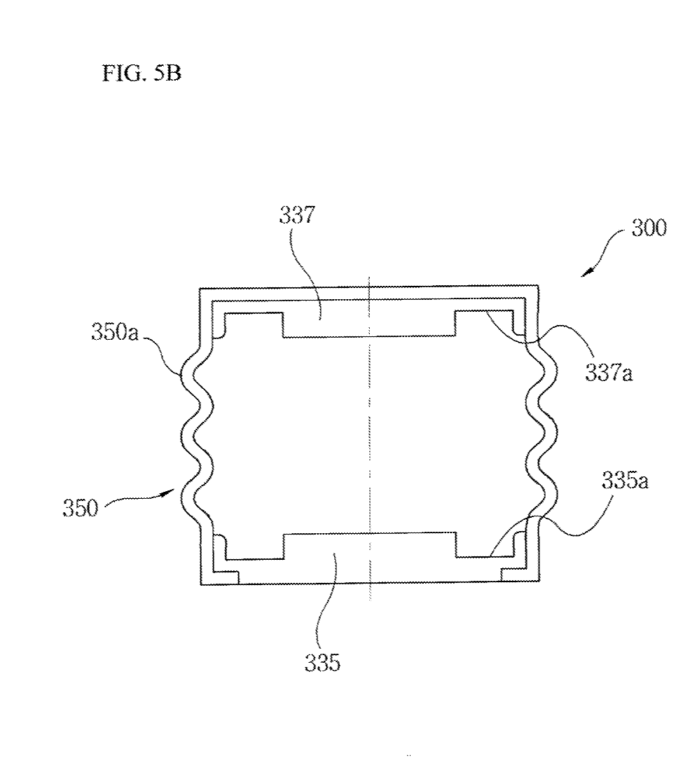

FIG. 4 is a perspective view showing a shock absorbing unit according to an embodiment of the present invention, and FIGS. 5A and 5B are front views showing shock absorbing units according to other embodiments of the present invention.

A shock absorbing unit 100 according to the present invention is inserted into a sole or a heel of a shoe, and includes an elastic member 140 which functions to absorb the shock of a wearer when he or she walks, a first locking part 135 which is placed under the elastic member 140 and has on an upper surface thereof an annular seating part on which an end of the elastic member 140 is seated, a second locking part 137 which is placed above the elastic member 140 and has on a lower surface thereof an annular seating part on which an end of the elastic member 140 is seated, and a supporting member 150 which has a receiving part that receives the elastic member 140 therein and is connected at opposite ends thereof to the first and second locking parts 135 and 137.

The elastic member 140 absorbs and mitigates shock acting on the heel, namely, the calcaneus when walking, and reduces the fatigue of the body and feet by rebound resilience.

The elastic member 140 according to the present invention comprises a coil spring. The elastic member may comprise a plate coil spring having a rectangular cross-section or a coil spring having a circular cross-section.

As an embodiment of the present invention, the plate coil spring having the rectangular cross-section is proposed. When a general coil spring is compressed by a load, upper and lower portions of the spring may collide with each other. In the case of the coil spring having the circular cross-section, the outer circumference, of the coil spring may be damaged by a collision between the upper and lower portions of the spring. However, in the case of the plate coil spring having the rectangular cross-section, planes of the spring come into contact with each other in the event of a collision between upper and lower portions of the spring, so that damage to the spring caused by the collision can be minimized.

The lower and upper ends of the elastic member 140 are coupled, respectively, to the first and second locking parts 135 and 137. In this case, the elastic member 140 is firmly secured by the annular seating part which is provided on the inner surface of each locking part 135 or 137.

If the elastic member 140 is provided on the sole of the shoe, when a wearer walks, exercises or works with the shoe on, a load generated by his or her weight is transmitted through the shoe to the ground. At this time, the plate coil spring absorbs shock transmitted upwards from the ground, that is, shock transmitted to a walker by rebound resilience, thus dispersing the weight and mitigating the shock.

Thus, even when a wearer walks, exercises or works for a lengthy period of time, the fatigue of the feet and shock applied to the overall body are absorbed and relieved, so that balance is obtained in four directions, namely, forwards, backwards, leftwards and rightwards. As a result, the present invention provides functionality to the shoe, that is, promotes a wearer's health, affords convenience, and corrects his or her body.

The shoe of the present invention includes the supporting member 150 which has the receiving part to receive the elastic member 140 and is connected at opposite ends thereof to the first and second locking parts 135 and 137.

The supporting member 150 has the shape of an airbag tube that receives the elastic member 140, and performs a compressive operation using a weight relative to the elastic member 140 when the elastic member 140 is compressed or restored when walking, thus guaranteeing the reliability of the plate coil spring 140.

The supporting member 150 is made of a soft material, and the receiving part is formed into a bulged shape. Thereby, if a wearer undergoes shock during walking, the receiving part is compressed to support the elastic member 140.

The supporting member 150 of the present invention is thermally bonded to the first and second locking parts 135 and 137 by the high-frequency heat-treatment adhesion method.

To this end, the first and second locking parts 135 and 137 are made of a thermoplastic polyurethane (hereinafter, referred to as TPU) material. The supporting member 150 is made of a soft TPU material.

As such, all of the supporting member 150 and the first and second locking parts 135 and 137 are made of the TPU material, so that they may be thermally bonded to each other.

Since respective surfaces of the supporting member 150 and the first and second locking parts 135 and 137 which are made of the same type of TPU material are melted by heat and then combined with each other, they may be perfectly attached to each other. Further, even if a large load acts on the shoe, the supporting member 150 and the first and second locking parts 135 and 137 never separate from each other, and the air present in the supporting member 150 serves as an airbag, thus serving to absorb shock and support the elastic member 140.

That is, since the supporting member 150 is made of the soft TPU material, it may perform the compressive operation to correspond to the movement of the elastic member 140 which is compressed or restored.

FIGS. 5A and 5B are front views showing shock absorbing units according to other embodiments of the present invention. According to these embodiments, a plurality of wrinkles 250a and 350a is formed on the receiving parts of the respective supporting members 250 and 350 in a horizontal direction.

The wrinkles 250a and 350a may be formed in two rows as shown in FIG. 5A, or may be formed in three rows as shown in FIG. 5B.

If the wrinkles 250a or 350a are subjected to shock when a wearer walks, the wrinkles 250a or 350a are compressed, thus supporting the elastic member 140. Further, the wrinkles 250a or 350a may perform the compressive operation to correspond to the movement of the elastic member 140 which is compressed or restored.

Hereinafter, a sole equipped with the above-mentioned shock absorbing unit will be described.

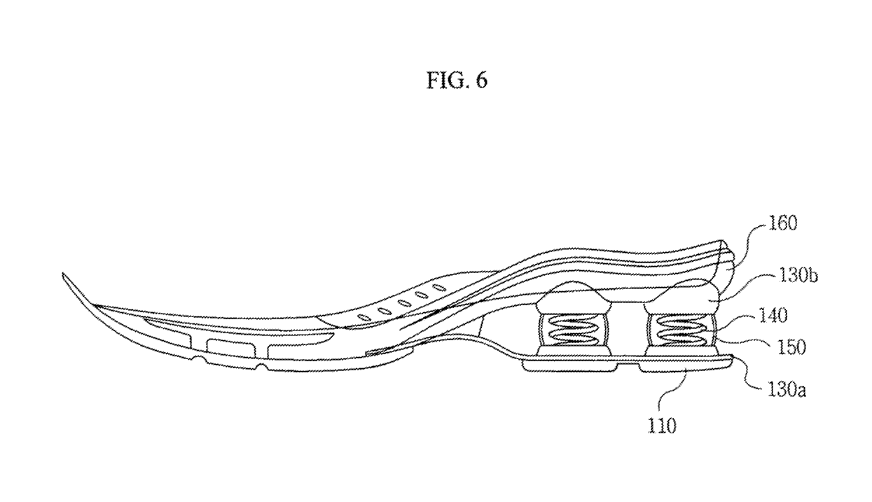

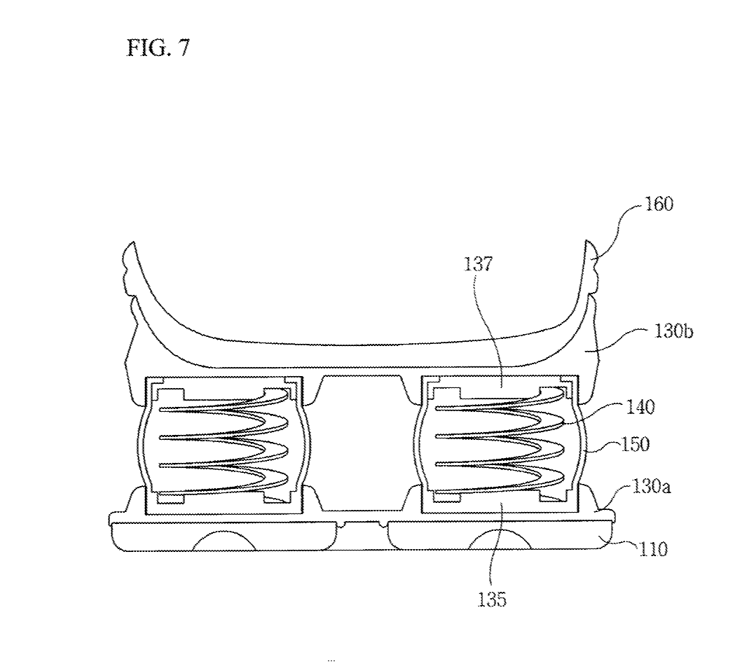

FIG. 6 is a side view showing a sole of a shoe having four shock absorbing units according to the present invention, and FIG. 7 is a rear view showing the sole of the shoe having the four shock absorbing units according to the present invention. The sole of the present invention includes the elastic member 140 which is disposed between the outsole 110 and the upper sole 160. A first holding member 130a is mounted to the upper surface of the outsole 110. The outsole 110 is firmly attached to the lower surface of the first holding member 130a using glue or a high-strength adhesive.

The bottom of the outsole 110 is in direct contact with the ground. Preferably, the bottom is made of an elastomer, polyurethane (PU), or rubber having elasticity in order to absorb shock and prevent slippage when the outsole 110 is in contact with the ground.

The outsole 110 is made of the above-mentioned material to provide elasticity and prevent slippage. Moreover, a plurality of protrusions or an uneven part having depressions and prominences is provided on the bottom to provide higher elasticity and more efficiently prevent slippage.

Further, the outsole 110 is constructed so that an anterior portion and a posterior portion are integrated with each other. If the outsole 110 is shaped to be divided into the anterior portion and the posterior portion, a walker may trip over a stone or a protruding object, and such an object may get caught in a gap between the anterior and posterior portions, thus making walking to hard. Therefore, in order to solve the problems, the outsole 110 is formed into a single structure.

The upper sole 160 of the present invention is disposed above the outsole 110. A lower surface of the upper sole 160 is firmly attached to a second holding member 130b using glue or a high-strength adhesive. The upper sole 160 is in direct contact with the sole of a wearer's foot, or an inner sole is placed on an upper surface of the upper sole 160.

The first locking part 135 is placed on the first holding member 130a which is mounted on the outsole 110. The annular seating part is formed in the first locking part 135 to seat the elastic member 140 therein. Thereby, the elastic member 140 is accommodated in the receiving part.

The second locking part 137 is placed on the top of the elastic member 140, and has on the lower surface thereof the annular seating part. The second holding member 130b is placed on the second locking part 137 and is attached to a lower surface of the upper sole 160.

The first and second locking parts 135 and 137 and the first and second holding members 130a and 130b are thermally bonded to each other by a high-frequency heat-treatment adhesion method.

To this end, the first and second locking parts 135 and 137 and the first and second holding members 130a and 130b are made of a TPU material.

As such, the first and second locking parts 135 and 137 and the first and second holding members 130a and 130b which are made of the same type of TPU material may be thermally bonded to each other, so that they can be more firmly adhered to each other, thus solving a problem occurring in the prior art, that is, they prevent the separation of the above components because of the adhesive force being reduced by the shoe being used.

The supporting member 150 is connected between the first and second holding members 130a and 130b, thus preventing the separation and removal of the elastic member 140 which provides repetitive elastic deformation while walking, and preventing contamination and to damage caused by foreign matter.

The supporting member 150 according to the present invention is connected to the first and second locking parts 135 and 137 which are coupled to the first and second holding members 130a and 130b. In this case, the lower end of the supporting member 150 is connected to the first locking part 135, and the upper end of the supporting member 150 is connected to the second locking part 137, and then the thermal bonding or the high-frequency heat-treatment adhesion is conducted, so that the shoe is safe and comfortable.

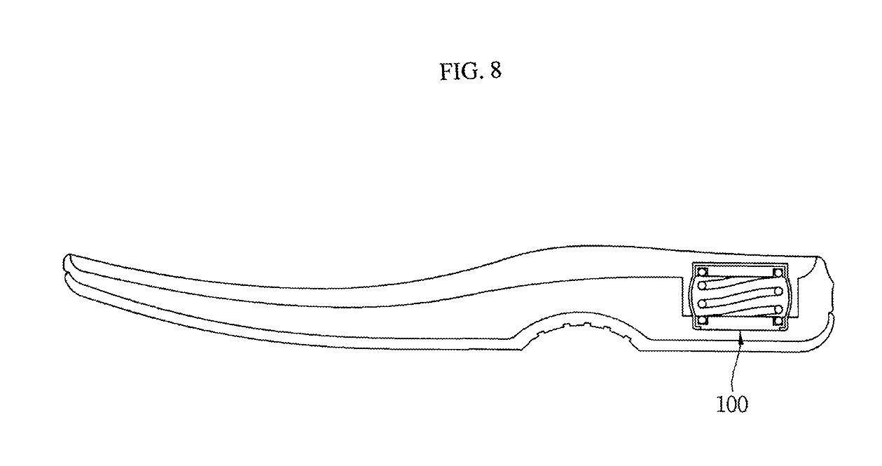

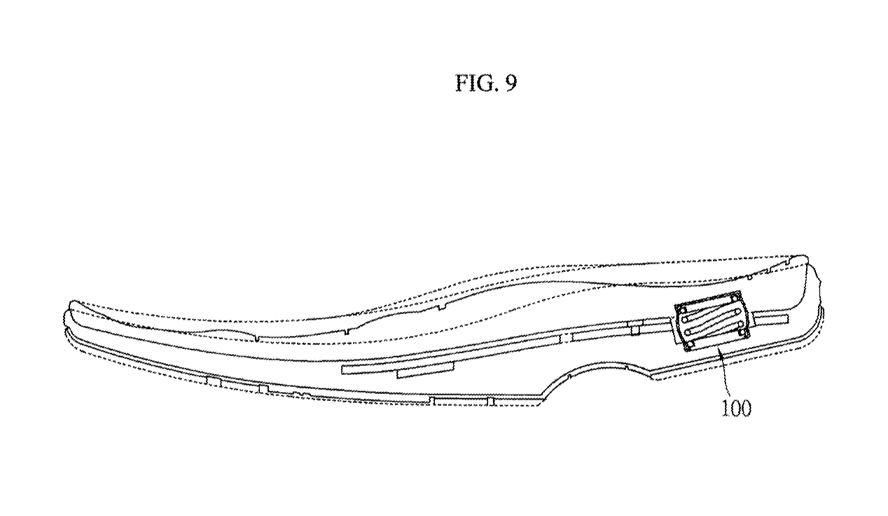

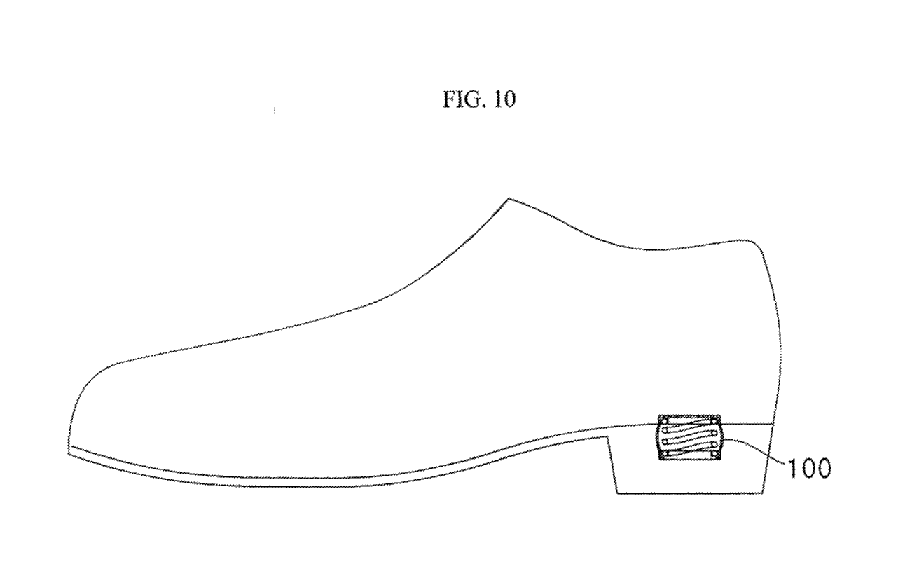

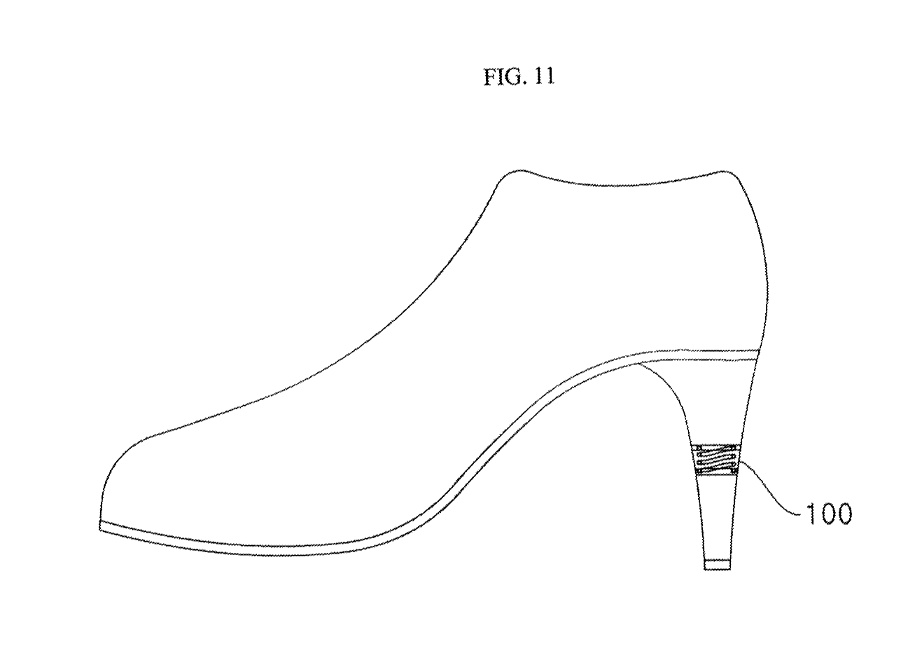

FIG. 8 is a side view showing a shoe according to an embodiment of the present invention, in which one shock absorbing unit is inserted into the shoe, FIG. 9 is a side view showing a shoe according to another embodiment of the present invention, in which one shock absorbing unit is inserted into the shoe, FIG. 10 is a side view showing a woman's shoe into which the shock absorbing unit of the present invention is inserted, and FIG. 11 is a side view showing a heel of a woman's shoe to which the shock absorbing unit of the present invention is mounted.

As such, one shock absorbing unit 100 according to the present invention is provided at a position which is in contact with a wearer's calcaneus, thus absorbing shock.

For example, the shock absorbing unit 100 of the present invention may be inserted into a sole of a canvas shoe or sneaker having a flat outsole, and besides, may be inserted into a heelless shoe having no heel, thus absorbing shock caused by a load when a wearer walks.

Further, the shock absorbing unit 100 of the present invention may also be applied to a woman's shoe.

In the case of a shoe having a relative low heel, the shock absorbing unit 100 of the present invention is inserted into a position corresponding to a wearer's calcaneus to absorb shock caused by a load during walking. Further, in the case of a shoe having a high heel, the shock absorbing unit 100 of the present invention may be mounted to the heel in such a way as to be installed in the heel or exposed to the outside of the heel.

FIG. 11 shows the shock absorbing unit 100 of the present invention which is inserted into the heel. However, the shock absorbing unit 100 of the present invention may be mounted to the heel in such a way as to be exposed to the outside, and absorbs shock while walking to reduce fatigue and remedies the deformed leg, spine, and other parts to correct the imbalance of the body.

As described above, the present invention is advantageous in that it is provided with a supporting member to prevent the removal or separation of an elastic member, thus absorbing shock and increasing durability, and, when the elastic member is compressed and then restored during walking, the supporting member primarily absorbs the initial pressure and then absorbs shock using rebound resilience, thus remarkably increasing the shock absorbing function of a shoe.

Further, the present invention is advantageous in that first and second locking parts locking an elastic member at upper and lower positions can be easily and conveniently coupled to a supporting member by high-frequency heat-treatment adhesion, so that assembly work is easier and assembly time is shortened in comparison with the conventional shock absorbing shoe, and thus productivity can be increased.

Further, in the case of having four shock absorbing units, they evenly distribute the load of a wearer's weight in a manner similar to that of a shock absorber of a four-wheel-drive car, thus protecting the ankle, knee, spine, and other parts, therefore straightening the body, and a wearer can walk more rapidly and shock can be absorbed owing to the rebound resilience, so that safety is achieved and fatigue is reduced, and muscles which are not used are contracted and relaxed to help the leg, spine, and other parts, thus providing balance in four directions.

Therefore, when a wearer walks with the shock absorbing shoe of the present invention on, the deformed body part can be repaired.

Further, a supporting member having the shape of an airbag tube is adhered to a locking part by high-frequency heat-treatment adhesion, thus preventing the entrance of foreign matter, preventing a shock absorbing unit from rusting or being damaged or removed, therefore allowing a wearer to be in a pleasant state of mind when using the shoe.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A shock absorbing unit inserted into a sole or heel of a shoe, comprising:
an elastic member absorbing shock of a wearer during walking;
a first locking part placed under the elastic member, and having on an upper surface thereof an annular seating part so that an end of the elastic member is seated therein;
a second locking part placed above the elastic member, and having on a lower surface thereof an annular seating part so that an end of the elastic member is seated therein; and
a supporting member having a receiving part that receives the elastic member, the supporting member being connected at opposite ends thereof to the first and second locking parts.

2. The shock absorbing unit as set forth in claim 1, wherein the elastic member is selected from a group consisting of a plate coil spring having a rectangular cross-section and a coil spring having a circular cross-section.

3. The shock absorbing unit as set forth in claim 1, wherein the supporting member has a shape of an airbag tube which receives the elastic member and is compressed or restored to correspond to an operation of the elastic member that is compressed or restored during walking.

4. The shock absorbing unit as set forth in claim 3, wherein the supporting member is made of a soft material, and the receiving part has a bulged shape, so that, if the supporting member is subjected to shock when a wearer walks, the receiving part is compressed to support the elastic member.

5. The shock absorbing unit as set forth in claim 3, wherein the supporting member is made of a soft material, and the receiving part has a plurality of wrinkles formed in a horizontal direction, so that, if the supporting member is subjected to shock when the wearer walks, the wrinkles of the receiving part are compressed to support the elastic member.

6. The shock absorbing unit as set forth in claim 1, wherein the first and second locking parts and the supporting member are thermally bonded to each other by a high-frequency heat-treatment adhesion method.

7. The shock absorbing unit as set forth in claim 1, wherein the first and second locking parts are made of a thermoplastic polyurethane (TPU) material, and the supporting member is made of a soft TPU material.

8. A shock absorbing sole, comprising:
a first holding member mounted on an outsole;
a shock absorbing unit mounted on the first holding member, and absorbing shock when a wearer walks;
a second holding member placed on the shock absorbing unit; and
an upper sole placed on the second holding member,
wherein the shock absorbing unit comprises:
an elastic member absorbing shock of the wearer during walking;
a first locking part placed under the elastic member, and having on an upper surface thereof an annular seating part so that an end of the elastic member is seated therein;
a second locking part placed above the elastic member, and having on a lower surface thereof an annular seating part so that an end of the elastic member is seated therein; and
a supporting member having a receiving part that receives the elastic member, the supporting member being connected at opposite ends thereof to the first and second locking parts.

9. The shock absorbing sole as set forth in claim 8, wherein the elastic member is selected from a group consisting of a plate coil spring having a rectangular cross-section and a coil spring having a circular cross-section.

10. The shock absorbing sole as set forth in claim 8, wherein the supporting member has to a shape of an airbag tube which receives the elastic member and is compressed or restored to correspond to an operation of the elastic member that is compressed or restored during walking.

11. The shock absorbing sole as set forth in claim 10, wherein the supporting member is made of a soft material, and the receiving part has a bulged shape, so that, if the supporting member is subjected to shock when a wearer walks, the receiving part is compressed to support the elastic member.

12. The shock absorbing sole as set forth in claim 10, wherein the supporting member is made of a soil material, and the receiving part has a plurality of wrinkles formed in a horizontal direction, so that, if the supporting member is subjected to shock when the wearer walks, the wrinkles of the receiving part are compressed to support the elastic member.

13. The shock absorbing sole as set forth in claim 8, wherein the first and second locking parts and the supporting member are thermally bonded to each other by a high-frequency heat-treatment adhesion method.

14. The shock absorbing sole as set forth in claim 8, wherein the first and second locking parts are made of a thermoplastic polyurethane (TPU) material and the supporting member is made of a soft TPU material.

15. The shock absorbing sole as set forth in claim 8, wherein the first and second locking parts and the first and second holding members are thermally bonded to each other by a high-frequency heat-treatment adhesion method.

16. The shock absorbing sole as set forth in claim 8, wherein the first and second locking parts and the first and second holding members are made of a thermoplastic polyurethane (TPU) material.

17. The shock absorbing sole as set forth in claim 8, wherein one shock absorbing unit is provided at a position which is in contact with a wearer's calcaneus, thus absorbing shock.

18. The shock absorbing sole as set forth in claim 8, wherein four shock absorbing units are provided to support a wearer's calcaneus.

19. A shoe having a shock absorbing unit as set forth in claim 1, wherein the shock absorbing unit is mounted to a position which is in contact with a wearer's calcaneus in such a way as to be inserted into a heel or exposed to an outside of the heel.

20. The shock absorbing unit as set forth in claim 6, wherein the first and second locking parts are made of a thermoplastic polyurethane (TPU) material, and the supporting member is made of a soft TPU material.

21. The shock absorbing sole as set forth in claim 13, wherein the first and second locking parts are made of a thermoplastic polyurethane (TPU) material, and the supporting member is made of a soft TPU material.

22. The shock absorbing sole as set forth in claim 15, wherein the first and second locking parts and the first and second holding members are made of a thermoplastic polyurethane (TPU) material.

23. The shoe as set forth in claim 19, wherein the elastic member is selected from a group consisting of a plate coil spring having a rectangular cross-section and a coil spring having a circular cross-section.

24. The shoe as set forth in claim 19, wherein the supporting member has a shape of an airbag tube which receives the elastic member and is compressed or restored to correspond to an operation of the elastic member that is compressed or restored during walking.

25. The shoe as set forth in claim 24, wherein the supporting member is made of a soft material, and the receiving part has a bulged shape, so that, if the supporting member is subjected to shock when a wearer walks, the receiving part is compressed to support the elastic member.

26. The shoe as set forth in claim 24, wherein the supporting member is made of a soft material, and the receiving part has a plurality of wrinkles formed in a horizontal direction, so that, if the supporting member is subjected to shock when the wearer walks, the wrinkles of the receiving part are compressed to support the elastic member.

27. The shoe as set forth in claim 19, wherein the first and second locking parts and the in supporting member are thermally bonded to each other by a high-frequency heat-treatment adhesion method.

28. The shoe as set forth in claim 19, wherein the first and second locking parts are made of a thermoplastic polyurethane (TPU) material, and the supporting member is made of a soft is TPU material.

29. The shoe as set forth in claim 27, wherein the first and second locking parts are made of a thermoplastic polyurethane (TPU) material, and the supporting member is made of a soft TPU material.
